(19) United States
(12) Patent Application Publication
(10) Pub. No.: US 2006/0067284 A1
(43) Pub. Date: Mar. 30, 2006

(54) Prepaid internet protocol-based services facilitation method and apparatus

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/951,560

(22) Filed: Sep. 28, 2004

(51) Int. Cl. H04Q 7/24

(52) U.S. Cl. 370/338

(57) ABSTRACT

Prepaid Internet Protocol-based services for a plurality of Internet Protocol-based services are provisioned by automatically and dynamically determining, for a given mobile node, the Internet Protocol-based services for which the mobile node has prepaid access, and then providing an authentication message (for example, to a supporting packet data serving node) that comprises, at least in part, identification of at least a first particular Internet Protocol-based service to which at least a first prepaid accounting quota attribute applies.

### TECHNICAL FIELD

This invention relates generally to prepaid Internet Protocol-based services.

### BACKGROUND

Various known communication systems are capable of supporting one or more Internet Protocol-based services such as, for example, voice and various data services. As another example, a given network may support both Internet Protocol version 4 sessions and Internet Protocol version 6 sessions for authorized subscribers. In turn, subscriber devices that support multiple Internet Protocol-based services, including so-called dual-stack devices that support both Internet Protocol version 4 and Internet Protocol version 6 access, are known. Such configurations provide the potential for considerable flexibility, particularly for mobile subscribers and client devices.

Prepaid services are also known. Fundamentally, prepaid services permit a given user or user organization to prepay for a particular kind or amount of system access. The corresponding system then debits that corresponding prepaid account in accordance with the subscriber's subsequent use of that prepaid system access. Such prepaid services permit considerable convenience and flexibility for users and their supporting administrative operations.

In some systems, such as CDMA2000 networks, a so-called prepaid accounting quota attribute serves to specify a particular subscriber's presently allocated prepaid quota. (This prepaid accounting quota attribute may, or may not, equal a given subscriber's complete line of prepaid credit in a given instance.) A problem can arise, however, when presently applying the use of such prepaid accounting quota attributes in conjunction with the support of multiple services, and especially when applied with respect to dual-stack capable subscriber units.

For example, a packet data serving node that receives a prepaid accounting quota attribute from an authentication, authorization, and accounting element for a given subscriber will typically be utterly uninformed as to whether that quota is to be applied to only Internet Protocol version 4 sessions, only Internet Protocol version 6 sessions, or both (there are numerous valid reasons why a given network operator may wish, for example, to preclude or permit prepaid services support for certain services and/or subscribers on a relatively dynamic basis). The situation can become even more complicated when usage of differing services occurs without any particular synchronicity such that a given subscriber may be using any given service, alone or in combination with other services, at any given time.

### BRIEF DESCRIPTION OF THE DRAWINGS

The above needs are at least partially met through provision of the prepaid Internet Protocol-based services facilitation method and apparatus described in the following detailed description, particularly when studied in conjunction with the drawings, wherein:

FIG. 1 comprises a general flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention;

FIG. 4 comprises a flow diagram as configured in accordance with various embodiments of the invention;

FIG. 5 comprises a block diagram as configured in accordance with various embodiments of the invention; and

FIG. 6 comprises a timing diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, facilitating the provision of Internet Protocol-based services in a system that supports a plurality of differing Internet Protocol-based services comprises automatically and dynamically determining, for a given mobile node, the Internet Protocol-based services for which the given mode node has prepaid access, and then using an authentication message to indicate, at least in part, identification of one or more of the Internet Protocol-based services to which the mobile node has prepaid access and a prepaid accounting quota attribute as corresponds to such Internet Protocol-based services to which the mobile node as prepaid access.

As desired, such an authentication message can comprise a single message or a plurality of messages that convey, in the aggregate, the indicated content. These teachings are applicable to facilitate prepaid authorization of a single service or of a plurality of services. Further, as desired, these teachings are applicable to permit different kinds and/or rates of prepaid support to be utilized for different Internet Protocol-based services.

So configured, for example, a packet data serving node can receive such an authentication message from an authentication, authorization, and accounting element and use that conveyed information to facilitate the provision of prepaid services to a given mobile node with respect to a plurality of candidate Internet Protocol-based services essentially regardless of which services are utilized or when those services are utilized vis-a-vis one another. In a preferred implementation a mobile node requires no modification to assure compatible operation with these processes.

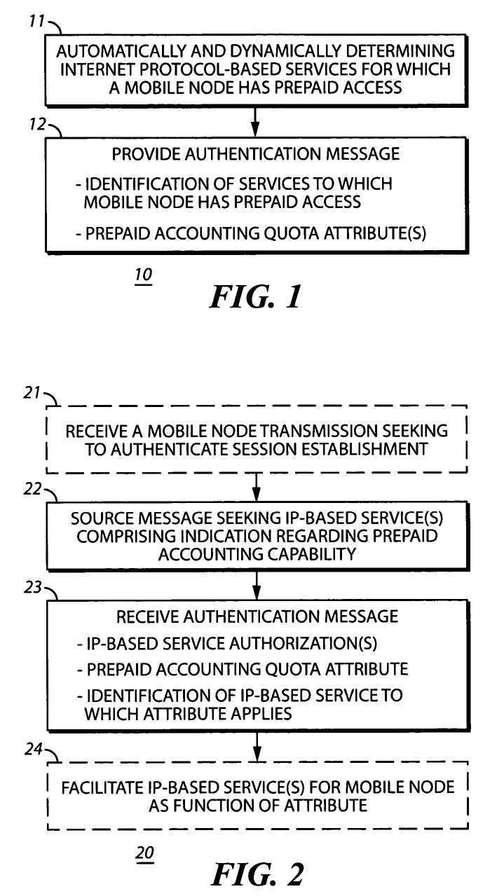

These and other benefits may become more evident upon making a thorough review and study of the following detailed description. Referring now to the drawings, and in particular to FIG. 1, this overall process 10 provides for automatically and dynamically determining 11, for a given mobile node, an Internet Protocol-based service (or services) (such as, but not limited to, Internet Protocol version 4 service and/or Internet Protocol version 6 service) for which the given mobile node has prepaid access. In a preferred embodiment, an authentication, authorization, and accounting element can effect this determination. In such a case, this determination can comprise a response to reception of a message that corresponds to a transmission from the mobile node that seeks an Internet Protocol-based service, which message comprises, at least in part, an indication regarding prepaid accounting capability (as corresponds, for example, to a packet data serving node).

This process 10 then provides for provision 12 of an authentication message that comprises, at least in part, identification of each of the Internet Protocol-based services to which the mobile node has prepaid access, and a prepaid accounting quota attribute as corresponds to each of the Internet Protocol-based services to which the mobile node has prepaid access. Depending upon the particular configuration deployed, this authentication message can comprise only a single prepaid accounting quota attribute or can comprise a plurality of discrete prepaid accounting quota attributes (where, for example, each of some or all of a plurality of services has a corresponding discrete and separate prepaid accounting quota attribute).

Additional details will now be provided with respect to the provisioning and support of such a process 10.

The above process can be facilitated in part by a subsidiary process 20 implemented, for example though not necessarily, by a packet data serving node. By this exemplary approach 20, the enabling platform of choice sources 22 a message that corresponds to a transmission from a mobile node seeking an Internet Protocol-based service, which message comprises, at least in part, an indication regarding the enabling platform's own prepaid accounting capability (for example, whether the enabling platform is, in fact, ready, able, and willing to support prepaid accounting support for the mobile node). (In a typical scenario, this mobile node transmission is likely first received 21 by the enabling platform and will typically comprise a message seeking to authenticate establishment of a session (or sessions) on behalf of the mobile node in accordance with well understood prior art practice.)

In a preferred approach the enabling platform sources 22 this message by transmitting the message to at least one authentication, authorization, and accounting element. In such a case, the message itself can comprise, for example, an access-request message, an accounting-request message, or the like. As noted earlier, this message can also comprise a single message or can be parsed into two or more messages. It is also contemplated that such a message can convey only a single access request (as corresponds to a single Internet Protocol-based service) or can comprise a first message as corresponds to a first access request, a second message as corresponds to a second access request, and so forth as desired. Pursuant to a typical embodiment this message will likely comprise at least a part of a point-to-point protocol network control protocol as is otherwise generally well understood in the art. (Those skilled in the art will understand that RADIUS messages such as access-request and access-accept are not typically considered part of Network Control Program (NCP) procedures. Though such messages usually happen in conjunction with NCP procedures, they are separable and not ordinarily required. Pursuant to a preferred approach, such RADIUS traffic will occur before and/or after NCP negotiations.)

In response to having sourced 22 this message, the enabling platform then receives 23 a corresponding authentication message. In an illustrative example this authentication message comprises, at least in part, an authorization to provide the Internet Protocol-based service to the mobile node, a prepaid accounting quota attribute as corresponds to the mobile node, and identification of a particular Internet Protocol-based service (or services), from amongst a plurality of available differing Internet Protocol-based services, to which the prepaid accounting quota attribute applies.

Again, this authentication message can comprise a single integrated response or can be parsed into a plurality of constituent messages. As a non-exhaustive illustration of the latter point, reception of the authentication message can comprise receiving at least a first message comprising an authorization to provide a plurality of Internet Protocol-based services for the mobile node, a second message comprising a prepaid accounting quota attribute as corresponds to a first one of the plurality of Internet Protocol-based services for the mobile node, and a third message comprising a prepaid accounting quota attribute as corresponds to a second one of the plurality of Internet Protocol-based services for the mobile node. Such messages can be separated in time as appropriate to the needs of a given application. For example, with reference to the illustration just presented, the second message can be sourced subsequent to completing a control protocol for a corresponding Internet Protocol access procedure.

The prepaid accounting quota attribute can vary to reflect the prepaid billing paradigm and typically will specify an amount of prepaid resources as may be consumed by a given mobile node (or corresponding user group) with respect to usage of a corresponding Internet Protocol-based service. For example, when the prepaid billing provides for a particular amount of time, then the prepaid accounting quota attribute can itself comprise a quantity of time (such as the entire amount of presently available prepaid time or some lesser quantity thereof). As another example, when the prepaid billing provides for a particular quantity of data, then the prepaid accounting quota attribute can itself comprise a measure of data. As yet another example, the prepaid accounting quota attribute can relate to a plurality of consumables (such as both a particular amount of time and a particular quantity of data).

In a preferred though optional approach, the enabling platform then facilitates 24 one or more authorized Internet Protocol-based services for the mobile node and controls that facilitation as a function, at least in part, of the prepaid accounting quota attribute (or attributes) as corresponds to that (or those) Internet Protocol-based services. It should be noted that these teachings are sufficiently flexible to permit facilitation of prepaid services that are rendered temporally coincident, at least in part, with one another and/or that are provided in a temporally discrete fashion.

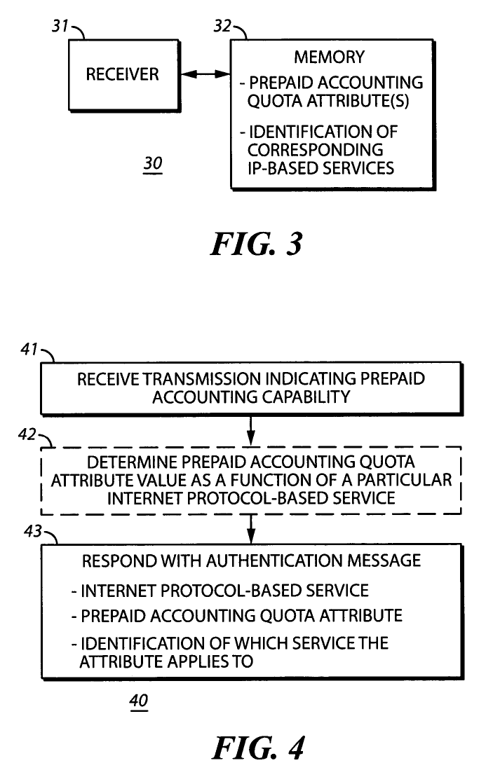

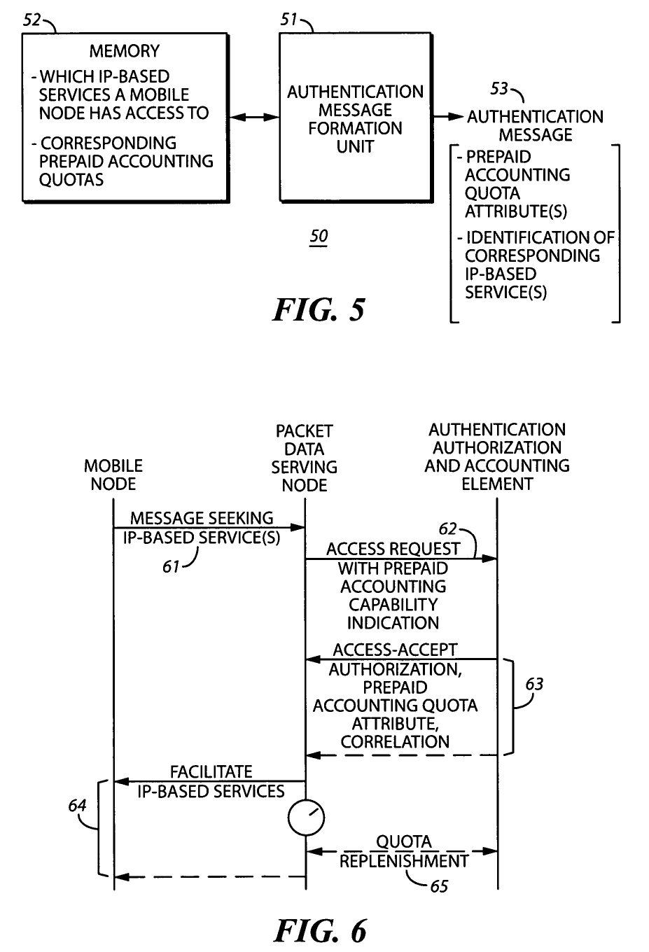

As noted earlier, and referring now to FIG. 3, a packet data serving node 30 will readily serve as an enabling platform to effect such a process 20. Such an apparatus will typically comprise a receiver 31 and a memory 32 that is operably coupled thereto. The receiver will preferably be compatible with the communication medium of choice to permit viable interchanges with one or more mobile nodes and other elements such as an authentication, authorization, and accounting element. Such receivers are well understood in the art and require no further elaboration here save to note that the receiver 31 should be configured and arranged to effect transmissions of requests for prepaid accounting quotas (in response, for example, to completion of a corresponding control protocol). Those skilled in the art will understand and appreciate that packet data serving nodes 30 typically comprise at least partially programmable platforms that can be readily configured to comport with these teachings.

The memory 32 has stored therein information such as at least one prepaid accounting quota attribute as corresponds to a mobile node and as was received via the receiver 31 in response to transmission of an authentication, authorization, and accounting request and identification of a particular Internet Protocol-based service, from amongst a plurality of available differing Internet Protocol-based services, to which the prepaid accounting quota attribute applies.

So configured, such a packet data serving node 30 can readily support the earlier described processes and thereby readily support the provision of prepaid services for a variety of Internet Protocol-based services for a given mobile node.

Referring now to FIG. 4, additional details regarding the formation of such authentication messages will be provided.

A corresponding process 40 provides for reception 41 of a message as described above that corresponds to a transmission from a mobile node seeking an Internet Protocol-based service. This message comprises, at least in part, an indication regarding prepaid accounting capability. For example, when sourced by a packet data serving node, the message can include an indication that the packet data serving node is, in fact, capable of handling and properly processing prepaid services for such a mobile node. Such an indication, of course, aids in obviating any requirement that this process 40 otherwise have independent access to such information. As noted earlier, such a message can comprise an access-request message as relates to a mobile node seeking one or both of Internet Protocol version 4 and version 6-based service.

This process 40 then optionally determines 42 a value for a prepaid accounting quota attribute as a function, at least in part, of the particular Internet Protocol-based service (or services) sought. This permits, for example, various accounting paradigms to be readily accommodated. To illustrate, when the particular Internet Protocol-based service sought by the mobile node comprises a first Internet Protocol-based service (such as Internet Protocol version 4), the process 40 can prompt determination of a first value for the prepaid accounting quota attribute. And when the particular Internet Protocol-based service sought by the mobile node comprises a second, different Internet Protocol-based service (such as Internet Protocol version 6), the process 40 can prompt determination of a second value for the prepaid accounting quota attribute that is independent of the first value and hence potentially different therefrom. For example, 30 minutes of prepaid billing may be available for Internet Protocol version 6 sessions while 120 minutes of prepaid billing are available for Internet Protocol version 4 sessions for a given mobile node or user group.

In any event, this process 40 then provides for responding 43 to the received message with the previously mentioned authentication message. Again, in a preferred approach, this authentication message comprises, at least in part, an authorization to provide the Internet Protocol-based service (or services) for the mobile node, a prepaid accounting quota attribute (or attributes) (as was optionally determined 42 earlier and/or as is otherwise determined or calculated in a given instance), and identification of a particular Internet Protocol-based service (or services), from amongst a plurality of available differing Internet Protocol-based services, to which the prepaid accounting quota attribute (or attributes) apply.

Such an authentication message can comprise, for example, an access-accept message and can comprise a single integral message or a plurality of messages as desired and/or as appropriate to the needs or requirements of a given application. This authentication message may also include a single prepaid accounting quota attribute or a plurality of such attributes to reflect a corresponding plurality of Internet Protocol-based services.

Those skilled in the art will recognize and appreciate that these teachings permit the ready determination and/or provisioning of prepaid billing information on a service-by-service basis, which information in turn permits network elements such as packet data serving nodes to efficiently and effectively provide a variety of prepaid billing services to a user population of subscribers.

To illustrate, and referring now to FIG. 6, a given mobile node (capable, in this example, of multi-stacked services) transmits a message 61 seeking Internet Protocol-based services to a packet data serving node. The latter transmits an access request message 62 to an authentication, authorization, and accounting element to preferably indicate this request along with indicating the capability of the packet data serving node to support prepaid accounting sessions. The authentication, authorization, and accounting element responds with one or more access-accept messages 63 that preferably include the requested authorization, one or more prepaid accounting quota attributes, and correlation information that ties a given attribute to a given service. The packet data serving node then uses this information to facilitate 64 the request Internet Protocol-based service (or services). Such facilitation can proceed in accord with ordinary practice in this regard if so desired, and can include decrementing the value of the attribute to reflect the mobile node's usage of the metered resource.

If desired, these teachings can also readily accommodate optional quota replenishment activities 65. For example, upon using up the presently allocated prepaid resource (or, perhaps more preferably, somewhat prior to fully consuming this resource), the packet data serving node and the authentication, authorization, and accounting element can conduct a process similar or essentially identical to that described above to effect allocation of additional prepaid resources for present use by the mobile node.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, the correlation between an authorized Internet Protocol-based service and a given prepaid quota attribute can be direct or indirect. As one illustration, a particular quota value can be presumed as a default value in the absence of a specific value being provided in an authentication message

We claim:

1. A method to facilitate provision of prepaid Internet Protocol-based services, comprising:
receiving a message that corresponds to a transmission from a mobile node seeking an Internet Protocol-based service which message comprises, at least in part, an indication regarding prepaid accounting capability;
responding to the message with an authentication message that comprises, at least in part:
authorization to provide the Internet Protocol-based service for the mobile node;
a prepaid accounting quota attribute;
identification of a particular Internet Protocol-based service, from amongst a plurality of available differing Internet Protocol-based services, to which the prepaid accounting quota attribute applies.

2. The method of claim 1 wherein receiving a message further comprises receiving an access-request message.

3. The method of claim 2 wherein receiving an access-request message further comprises receiving an access-request message from a packet data serving node.

4. The method of claim 1 wherein receiving a message that corresponds to a transmission from a mobile node seeking an Internet Protocol-based service further comprises receiving a message that corresponds to a transmission from a mobile node seeking an Internet Protocol-based service comprising at least one of:
an Internet Protocol version 4-based service;
an Internet Protocol version 6-based service.

5. The method of claim 1 wherein responding to the message with an authentication message further comprises responding to the message with an access-accept message.

6. The method of claim 1 wherein the prepaid accounting quota attribute specifies an amount of prepaid resources as may be consumed by the mobile node with respect to usage of the particular Internet Protocol-based service.

7. The method of claim 6 wherein the prepaid accounting quota attribute specifies at least one of:
a quantity of time;
a measure of data.

8. The method of claim 1 and further comprising determining a value for the prepaid accounting quota attribute as a function, at least in part, of the particular Internet Protocol-based service.

9. The method of claim 8 wherein determining a value for the prepaid accounting quota attribute as a function, at least in part, of the particular Internet Protocol-based service further comprises:
when the particular Internet Protocol-based service comprises a first Internet Protocol-based service, determining a first value for the prepaid accounting quota;
when the particular Internet Protocol-based service comprises a second Internet Protocol-based service, which second Internet Protocol-based service is different from the first Internet Protocol-based service, determining a second value for the prepaid accounting quota, which second value may be different from the first value.

10. The method of claim 1 wherein responding to the message with an authentication message that comprises, at least in part, a prepaid accounting quota attribute further comprises responding to the message with an authentication message that comprises, at least in part, a first prepaid accounting quota attribute and a second prepaid accounting quota attribute.

11. The method of claim 10 wherein responding to the message with an authentication message that comprises, at least in part, identification of a particular Internet Protocol-based service, from amongst a plurality of available differing Internet Protocol-based services, to which the prepaid accounting quota attribute applies further comprises responding to the message with an authentication message that comprises, at least in part:
identification of a first particular Internet Protocol-based service to which the first prepaid accounting quota attribute applies;
identification of a second particular Internet Protocol-based service to which the second prepaid accounting quota attribute applies, wherein the second particular Internet Protocol-based service is different from the first particular Internet Protocol-based service.

12. The method of claim 11 wherein the first particular Internet Protocol-based service comprises an Internet Protocol version 4-based service and the second particular Internet Protocol-based service comprises an Internet Protocol version 6-based service.

13. A method to facilitate provision of prepaid Internet Protocol-based services in a system that supports a plurality of differing Internet Protocol-based services, comprising:
automatically and dynamically determining, for a given mobile node, the Internet Protocol-based services for which the given mobile node has prepaid access;
providing an authentication message that comprises, at least in part:
identification of each of the Internet Protocol-based services to which the mobile node has prepaid access;
a prepaid accounting quota attribute as corresponds to each of the Internet Protocol-based services to which the mobile node has prepaid access.

14. The method of claim 13 wherein automatically and dynamically determining further comprises automatically and dynamically determining at an authentication, authorization, and accounting element.

15. The method of claim 13 wherein automatically and dynamically determining, for a given mobile node, the Internet Protocol-based services for which the given mobile node has prepaid access further comprises automatically and dynamically determining, for a given mobile node, the Internet Protocol-based services for which the given mobile node has prepaid access in response to receiving a message that corresponds to a transmission from a mobile node seeking an Internet Protocol-based service which message comprises, at least in part; an indication regarding prepaid accounting capability.

16. The method of claim 13 wherein the Internet Protocol-based services comprise at least one Internet Protocol version 4-based service and at least one Internet Protocol version 6-based service.

17. The method of claim 13 wherein providing an authentication message that comprises, at least in part, a prepaid accounting quota attribute as corresponds to each of the Internet Protocol-based services to which the mobile node has prepaid access further comprises providing an authentication message that comprises a single prepaid accounting quota attribute.

18. The method of claim 13 wherein providing an authentication message that comprises, at least in part, a prepaid accounting quota attribute as corresponds to each of the Internet Protocol-based services to which the mobile node has prepaid access further comprises providing an authentication message that comprises a discrete and separate prepaid accounting quota attribute for at least some of the Internet Protocol-based services.

19. An apparatus for use in a system that provides prepaid Internet Protocol-based services comprising:
a memory having stored therein:
information regarding which Internet Protocol-based services, from amongst a plurality of available differing Internet Protocol-based services, a given mobile node has prepaid access to;
information regarding prepaid accounting quotas for those Internet Protocol-based services to which the given mobile node has prepaid access;
an authentication message formation unit that is operably coupled to the memory and having an output providing an authentication message that comprises, at least in part:
at least one prepaid accounting quota attribute;
identification of a particular one of the differing Internet Protocol-based services to which the prepaid accounting quota attribute applies.

20. The apparatus of claim 19 wherein the apparatus comprises an authentication, authorization, and accounting element.

21. The apparatus of claim 19 wherein the plurality of available differing Internet Protocol-based services comprises, at least in part, Internet Protocol version 4-based services and Internet Protocol version 6-based services.

22. The apparatus of claim 19 wherein the information regarding prepaid accounting quotas for those Internet Protocol-based services to which the given mobile node has prepaid access further comprises a discrete prepaid accounting quota for each of the Internet Protocol-based services to which the given mobile node has prepaid access.

23. The apparatus of claim 19 wherein the authentication message formation unit further comprises means for forming the authentication message.

24. The apparatus of claim 19 wherein the authentication message formation unit further comprises means for forming an authentication message that identifies each of the differing Internet Protocol-based services and that provides a prepaid accounting quota attribute for each of the differing Internet Protocol-based services.

25. A method to facilitate provision of prepaid Internet Protocol-based services, comprising:
sourcing a message that corresponds to a transmission from a mobile node seeking an Internet Protocol-based service which message comprises, at least in part, an indication regarding prepaid accounting capability;
receiving an authentication message that comprises, at least in part:
authorization to provide the Internet Protocol-based service for the mobile node;
a prepaid accounting quota attribute as corresponds to the mobile node;
identification of a particular Internet Protocol-based service, from amongst a plurality of available differing Internet Protocol-based services, to which the prepaid accounting quota attribute applies.

26. The method of claim 25 and further comprising receiving the transmission from the mobile node, wherein the transmission comprises a message seeking to authenticate establishment of a session on behalf of the mobile node.

27. The method of claim 25 wherein sourcing a message further comprises transmitting the message to at least one authentication, authorization, and accounting element.

28. The method of claim 25 wherein sourcing a message further comprises transmitting an access-request message.

29. The method of claim 25 and further comprising:
facilitating a first Internet Protocol-based service for the mobile node and controlling that facilitation as a function, at least in part, of the prepaid accounting quota attribute as corresponds to the first Internet Protocol-based service.

30. The method of claim 29 and further comprising:
facilitating a second Internet Protocol-based service for the mobile node and controlling that facilitation as a function, at least in part, of the prepaid accounting quota attribute as corresponds to the second Internet Protocol-based service, wherein the second Internet Protocol-based service is different from the first Internet Protocol-based service.

31. The method of claim 30 wherein facilitating a second Internet Protocol-based service comprises facilitating the second Internet Protocol-based service such that facilitation of the second Internet Protocol-based service coincides, at least in part, with facilitation of the first Internet Protocol-based service.

32. The method of claim 25 wherein sourcing a message further comprises sourcing the message from a packet data serving node.

33. The method of claim 25 wherein sourcing a message that corresponds to a transmission from a mobile node seeking an Internet Protocol-based service which message comprises, at least in part, an indication regarding prepaid accounting capability further comprises sourcing at least two messages wherein a first message corresponds to a first access request and a second message corresponds to a second access request.

34. The method of claim 33 wherein receiving an authentication message further comprises receiving at least a first message comprising the authorization to provide the Internet Protocol-based service for the mobile node and a second message comprising the prepaid accounting quota attribute.

35. The method of claim 34 wherein receiving at least a first message comprising the authorization to provide the Internet Protocol-based service for the mobile node and a second message comprising the prepaid accounting quota attribute further comprises:
receiving at least a first message comprising an authorization to provide a plurality of Internet Protocol-based services for the mobile node;
receiving a second message comprising a prepaid accounting quota attribute as corresponds to a first one of the plurality of Internet Protocol-based services for the mobile node;
receiving a third message comprising a prepaid accounting quota attribute as corresponds to a second one of the plurality of Internet Protocol-based services for the mobile node.

36. The method of claim 34 wherein sourcing the second message occurs subsequent to completing Control Protocol for a corresponding Internet Protocol access procedure as is facilitated by sourcing of the first message.

37. An apparatus to facilitate provision of prepaid Internet Protocol-based services, comprising:
a receiver;
a memory that is operably coupled to the receiver and having stored therein:
at least one prepaid accounting quota attribute as corresponds to a mobile node and as was received via the receiver in response to transmission of an authentication, authorization, and accounting request;
identification of a particular Internet Protocol-based service, from amongst a plurality of available differing Internet Protocol-based services, to which the prepaid accounting quota attribute applies.

38. The apparatus of claim 37 wherein the apparatus comprises a packet data serving node.

39. The apparatus of claim 37 wherein the at least one prepaid accounting quota attribute was received from an authentication, authorization, and accounting element.

40. The apparatus of claim 37 wherein the memory has stored therein a plurality of prepaid accounting quota attributes as corresponds to the mobile node.

41. The apparatus of claim 40 wherein each of the plurality of prepaid accounting quota attributes corresponds to a different one of a plurality of Internet Protocol-based services to which the mobile node has prepaid access.

42. The apparatus of claim 37 wherein the receiver further comprises means for transmitting a request for prepaid accounting quota.

43. The apparatus of claim 42 wherein the means for transmitting a request for prepaid accounting quota is responsive to completion of a control protocol.

44. A method to facilitate provision of prepaid Internet Protocol-based services, comprising:
sourcing a message as at least a part of completing a point-to-point protocol network control protocol that corresponds to a transmission from a mobile node seeking an Internet Protocol-based service which message comprises, at least in part, an indication regarding a prepaid capability;
receiving an authentication message in response to the message that comprises a prepaid accounting quota attribute as corresponds to the mobile node.

45. The method of claim 44 wherein sourcing a message further comprises transmitting the message to at least one authentication, authorization, and accounting element.

46. The method of claim 44 wherein sourcing a message further comprises transmitting an access-request message.

47. The method of claim 44 wherein sourcing a message further comprises transmitting an accounting-request message.

48. The method of claim 44 wherein the prepaid accounting quota attribute relates to a first Internet Protocol-based service, and further comprising:
facilitating the first Internet Protocol-based service for the mobile node and controlling that facilitation as a function, at least in part, of the prepaid accounting quota attribute.

49. The method of claim 48 wherein the authentication message further comprises a second prepaid accounting quota attribute that relates to a second Internet Protocol-based service, which second Internet Protocol-based service is different from the first Internet Protocol-based service, and further comprising:
facilitating the second Internet Protocol-based service for the mobile node and controlling that facilitation as a function, at least in part, of the second prepaid accounting quota attribute.

50. The method of claim 49 wherein facilitating a second Internet Protocol-based service comprises facilitating the second Internet Protocol-based service such that facilitation of the second Internet Protocol-based service coincides, at least in part, with facilitation of the first Internet Protocol-based service.

51. The method of claim 48 wherein receiving an authentication message further comprises receiving a plurality of authentication messages.

52. The method of claim 51 wherein receiving a plurality of authentication messages further comprises:
receiving a first authentication message that comprises the first prepaid accounting quota attribute;
receiving a second authentication message that comprises the second prepaid accounting quota attribute.
